(19) United States
(12) Patent Application Publication
(10) Pub. No.: US 2015/0048645 A1
(43) Pub. Date: Feb. 19, 2015

(54) OPEN ROOF CONSTRUCTION FOR A VEHICLE

(71) Applicants: Marcel Johan Christiaan Nellen, Merselo (NL); Stephan Christiaan Vervoort, Boxmeer (NL); Emile Frns Pop, Den Haag (NL); Justin De Boer, Amsterdam (NL)

(72) Inventors: Marcel Johan Christiaan Nellen, Merselo (NL); Stephan Christiaan Vervoort, Boxmeer (NL); Emile Frns Pop, Den Haag (NL); Justin De Boer, Amsterdam (NL)

(21) Appl. No.: 14/387,166

(22) PCT Filed: Mar. 6, 2013
(86) PCT No.: PCT/EP2013/054511

§ 371 Date: Sep. 22, 2014

(30) Foreign Application Priority Data
Mar. 26, 2012 (EP) 12161182.6

(51) Int. Cl. B60J 7/057; B60J 7/047

(52) U.S. Cl. CPC B60J 7/057; B60J 7/047
USPC 296/108; 296/219

(57) ABSTRACT

An open roof construction for a vehicle is provided, comprising a number of separate roof panels which are movable between a closed position for closing a roof opening of said vehicle and an opened position for at least partially freeing said roof opening. The open roof construction comprises a telescoping mechanism for moving said number of roof panels, substantially in a longitudinal direction of the vehicle, between the closed and opened positions. The telescoping mechanism is provided with a number of telescoping members which in a telescoping manner are movable relative to each other and wherein each panel is attached to and moved by a different one of said telescoping members.

### CROSS-REFERENCE TO RELATED APPLICATION

This application is a Section 371 National Stage Application of International Application PCT/EP2013/054511 filed Mar. 6, 2013 and published as WO2013/143815 A1 in English.

### BACKGROUND

The discussion below is merely provided for general background information and is not intended to be used as an aid in determining the scope of the claimed subject matter.

The invention relates to an open roof construction for a vehicle, comprising a number of separate roof panels which are movable between a closed position for closing a roof opening of said vehicle and an opened position for at least partially freeing said roof opening.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background

An open roof construction includes a telescoping mechanism for moving said number of roof panels, substantially in a longitudinal direction of the vehicle, between the closed and opened positions, which telescoping mechanism is provided with a number of telescoping members which in a telescoping manner are movable relative to each other and wherein each panel is attached to and moved by a different one of said telescoping members.

The use of such a telescoping mechanism, among others, offers the advantage that in the opened position of the roof panels a roof opening is obtained which, to a large amount, is free of obstacles and which, therefore, may be maximised (in correspondence with the constant demand for increasingly larger, unobstructed, roof openings in vehicles).

It is noted, that the invention also relates to a case in which only one roof panel is present. In such a case, generally the telescoping mechanism comprises two telescoping members, of which one is attached to the roof panel and the other is attached to a stationary part of the vehicle (e.g. the vehicle body).

In one embodiment, the open roof construction is provided with a single telescoping mechanism located substantially along a longitudinal center line of said roof panels. Such an embodiment, for example, may be used when the dimensions (and, thus, weight) of the roof panels are moderate and sufficient stability may be obtained by just a single, central, telescoping mechanism.

However, under certain circumstances (for example, when the dimensions, and thus weight, of the roof panels are more substantial) the open roof construction may be provided with two telescoping mechanisms located substantially at the opposite longitudinal edges of said roof panels.

In one embodiment of the open roof construction, each telescoping mechanism moves in a fixed direction. Said fixed direction will be determined by the relative (translating) telescoping movement of the telescoping members of the telescoping mechanism.

In an alternative embodiment however, which for example may be used in an open roof construction of which the roof panels have to describe a more complex (at least partially curved) track when moving between the closed and opened positions, each telescoping mechanism may move in a variable direction.

For example, it is possible that each telescoping mechanism is mounted for a rotation about an axis of rotation extending substantially in a transverse direction. As a result the direction of the telescoping movement of the telescoping mechanism may be varied (at any desired stage of the movement, for example before or during said movement).

In one embodiment, then, the telescoping mechanism is devised for carrying out its telescoping movement and its rotation about said axis of rotation substantially successively. That means that one of said movements (telescoping movement or rotation) substantially will be completed before the other one of said movements is carried out. For example, when moving the roof panels from the closed to the fully opened position initially a translating telescoping movement may be carried out, followed by a rotation of the telescoping mechanism.

Alternatively, the telescoping mechanism may be devised for carrying out its telescoping movement and its rotation about said axis of rotation at least partly simultaneously.

This means that a translating telescoping movement and said rotation at least partly are carried out at the same time.

In yet another embodiment of the open roof construction, each telescoping mechanism is attached to the vehicle at a position behind the roof opening, as seen in the longitudinal direction of said vehicle, such that the panels, when moved to the fully opened position, are located substantially behind said roof opening. As a result the free roof opening, in the fully opened position of the roof panels, may be maximised.

The open roof construction may be applied to a vehicle of the type having a rear trunk, in which case the telescoping mechanism may be devised for, in their fully opened position, positioning the panels in said trunk. It is noted, that especially in such a case the embodiment is favorable in which each telescoping mechanism can move in a variable direction (and, for example, may rotate around a transverse axis of rotation).

In one embodiment of the open roof construction, the roof opening comprises two opposite longitudinal edges which are defined by cant rails which are devised for maintaining their position along said longitudinal edges when the panels move between the closed and opened positions. This means, that said cant rails will maintain their original position at opposite longitudinal edges of the roof opening (connecting a forward body part—e.g. the so called A-beam—of the vehicle with a rearward body part—e.g. the so called C-beam—when the roof panels are moved to an opened position and, thus, add to the overall constructional stability of the vehicle).

However, as an alternative, it is possible that the roof opening comprises two opposite longitudinal edges which are defined by cant rails which are devised for moving along with the panels when these move between the closed and opened positions. Such an embodiment offers the vehicle the appearance of a convertible when the roof panels have moved to the opened position.

In such a case, each cant rail may comprise a number of cant rail members attached to longitudinal side edges of respective ones of the roof panels, which cant rail members are provided with cooperating connecting members for establishing a connection between successive cant rail members in the closed position of the roof panels. In the closed position of the roof panels the connecting members ensure that the cant rail members define rigid cant rails. When the roof panels have to be moved to the opened position, the connecting members will be disconnected from each other.

Although it is conceivable that each roof panel is attached to a respective telescoping member in a rigid manner, in one embodiment of the open roof construction the roof panels are attached to the respective telescoping members in a manner to allow a change of the relative position between a roof panel and the corresponding telescoping member. This allows more complicated movements of the roof panels (for example to take into account space limitations).

For example it is conceivable, that each roof panel is attached to a respective telescoping member through an axis of rotation extending substantially in a transverse direction. The rotation of a roof panel around such axis may be synchronised with the movement of the telescoping mechanism.

It is noted, that the telescoping mechanism may be rectilinear or curved. The resulting translating movement then also will be according to a straight or curved line, respectively.

### BRIEF DESCRIPTION OF THE DRAWINGS

Hereinafter aspects of the invention will be elucidated while referring to the drawings in which a number of embodiments of the open roof construction according the present invention are illustrated. In the drawings:

FIG. 1 shows, in perspective and schematically, a first embodiment of the open roof construction, in a closed position, an intermediate position and an opened position;

FIG. 2 shows, in perspective and schematically, a second embodiment of the open roof construction, in a closed position, an intermediate position and an opened position;

FIG. 3 shows, in perspective and schematically, a third embodiment of the open roof construction, in a closed position and in an opened position;

FIG. 4 shows, in perspective and schematically, a fourth embodiment of the open roof construction, in a closed position and in an opened position;

FIG. 5 shows, in a side elevational view and schematically, a fifth embodiment of the open roof construction, in a closed position, an intermediate position and in an opened position; and

FIG. 6 shows, similar to FIG. 1b, a sixth embodiment of the open roof construction.

### DETAILED DESCRIPTION OF THE ILLUSTRATIVE EMBODIMENTS

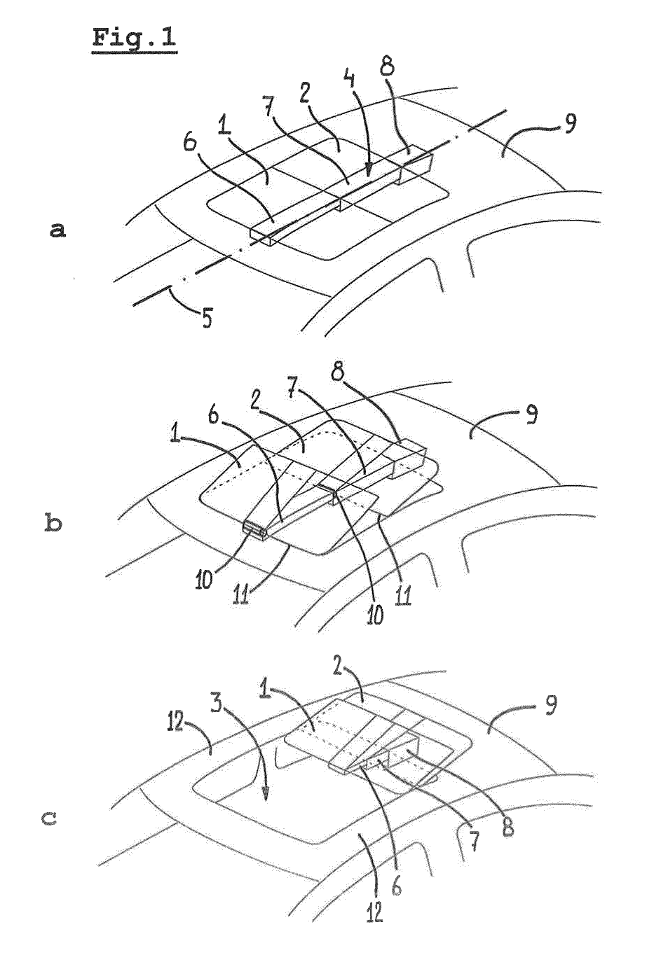

Firstly referring to FIG. 1, a first embodiment of a roof construction for a vehicle is illustrated, comprising two separate roof panels 1,2 which are movable between a closed position (figure la) for closing a roof opening 3 of said vehicle and an opened position (FIG. 1c) for at least partially freeing said roof opening.

A telescoping mechanism 4 is provided for moving said roof panels 1,2, substantially in a longitudinal direction 5 of the vehicle, between the closed and opened positions. The telescoping mechanism 4 is provided with a number of telescoping members 6-8 which in a telescoping manner are movable relative to each other. A first panel 1 is attached to and moved by telescoping member 6, whereas a second panel 2 is attached to and moved by telescoping member 7. In the illustrated embodiment telescoping member 8 is attached to a stationary roof part 9 at a position behind the roof opening 3, as seen in the longitudinal direction of said vehicle, such that the panels 1,2, when moved to the fully opened position, are located substantially behind said roof opening 3.

As appears clearly from FIG. 1, the open roof construction is provided with a single telescoping mechanism 4 located substantially along a longitudinal center line of said roof panels 1,2. The telescoping mechanism 4 moves in a fixed direction according to a translational movement, and thus its telescoping member 8 may be attached to the stationary roof part 9 in a fixed manner.

The roof panels 1,2 are attached to the respective telescoping members 6,7 in a manner to allow a change of the relative position between a roof panel and the corresponding telescoping member. For example, each roof panel 1,2 may be attached to the respective telescoping member 6,7 through an axis of rotation 10 (illustrated schematically in FIG. 1b only) extending substantially in a transverse direction (and in the illustrated embodiment in the immediate vicinity of a leading edge 11 of the respective roof panel).

In the embodiment of FIG. 1 the rotation of the panels 1,2 around the respective axis 10 and the telescoping (translating) movement of the telescoping mechanism 4 are synchronised in such a manner that firstly a rotation of the panels 1,2 occurs (from FIG. 1a to FIG. 1b) and next a translation (from FIG. 1b to FIG. 1c). It is conceivable, however, that such movements occur at least partly simultaneously and/or in a different order.

Finally FIG. 1c shows that the roof opening 3 comprises two opposite longitudinal edges which are defined by cant rails 12 which are devised for maintaining their position along said longitudinal edges when the panels 1,2 move between the closed and opened positions.

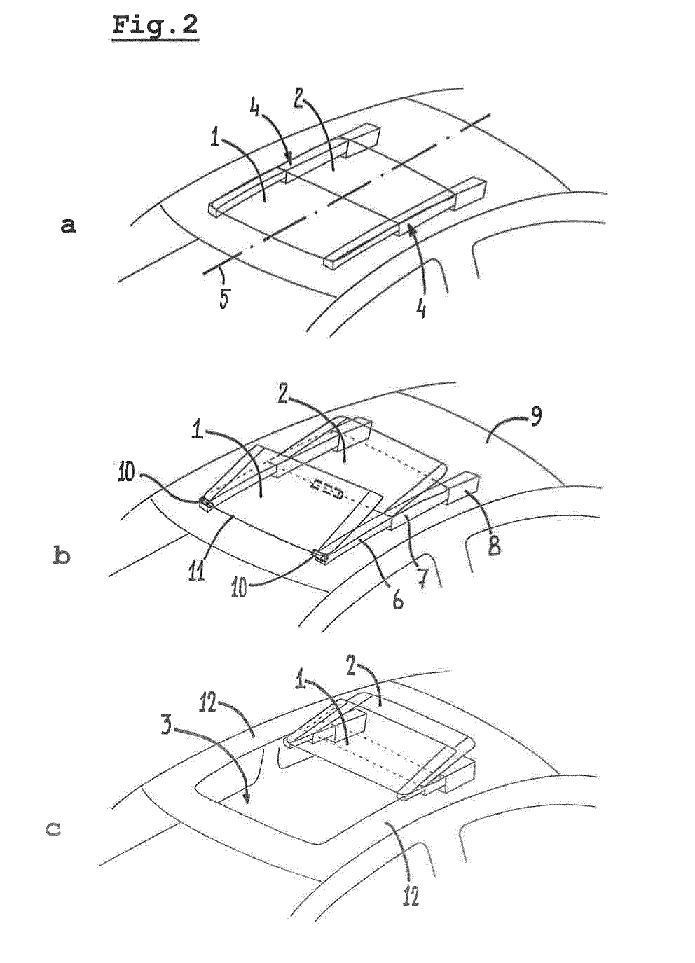

FIG. 2 shows (again in three successive positions) a second embodiment of the open roof construction which closely resembles the embodiment according to FIG. 1 and in which like parts are indicated by like reference numbers. The only difference with the previous embodiment is that this second embodiment comprises two telescoping mechanisms 4 located substantially at the opposite longitudinal edges of the roof panels 1,2. The operation of this embodiment is similar to that of FIG. 1 and will not be repeated here.

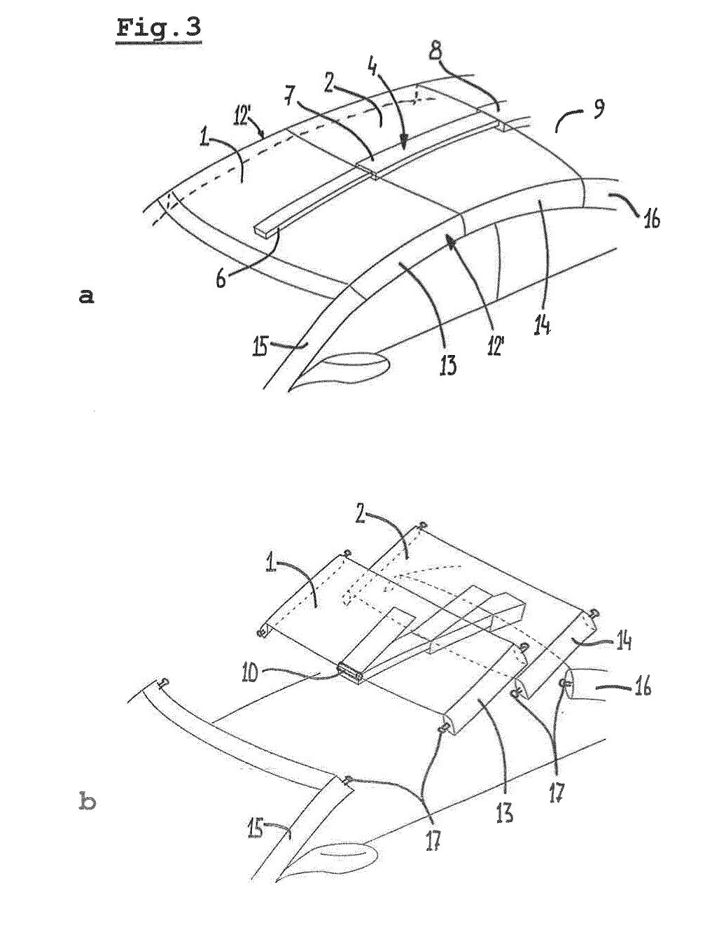

The third embodiment shown in FIG. 3 comprises a number of parts similar to FIG. 1 and thus provided with like reference numbers. In this case, however, the roof opening 3 comprises two opposite longitudinal edges which are defined by cant rails 12′ which are devised for moving along with the panels 1,2 when these move between the closed and opened positions. Each cant rail 12′ comprises a number of cant rail members 13,14 attached to longitudinal side edges of respective ones of the roof panels 1,2 (and stationary cant rail members 15,16 making part of the body of the vehicle). The cant rail members 13-16 are provided with cooperating connecting members 17 (indicated only schematically in FIG. 3b) for establishing

a connection between successive cant rail members 13-16 in the closed position of the panel members.

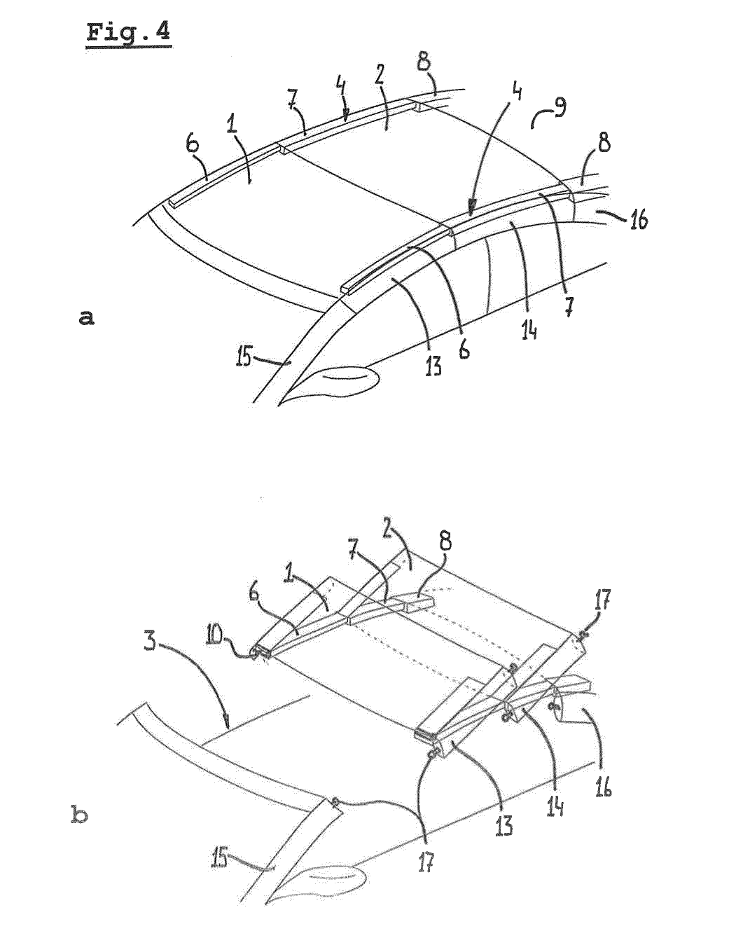

FIG. 4 shows a fourth embodiment which closely resembles the embodiment according to FIG. 3 and in which like parts are indicated by like reference numbers. The only difference with the previous embodiment is that this second embodiment again comprises two telescoping mechanisms 4 located substantially at the opposite longitudinal edges of the roof panels 1,2.

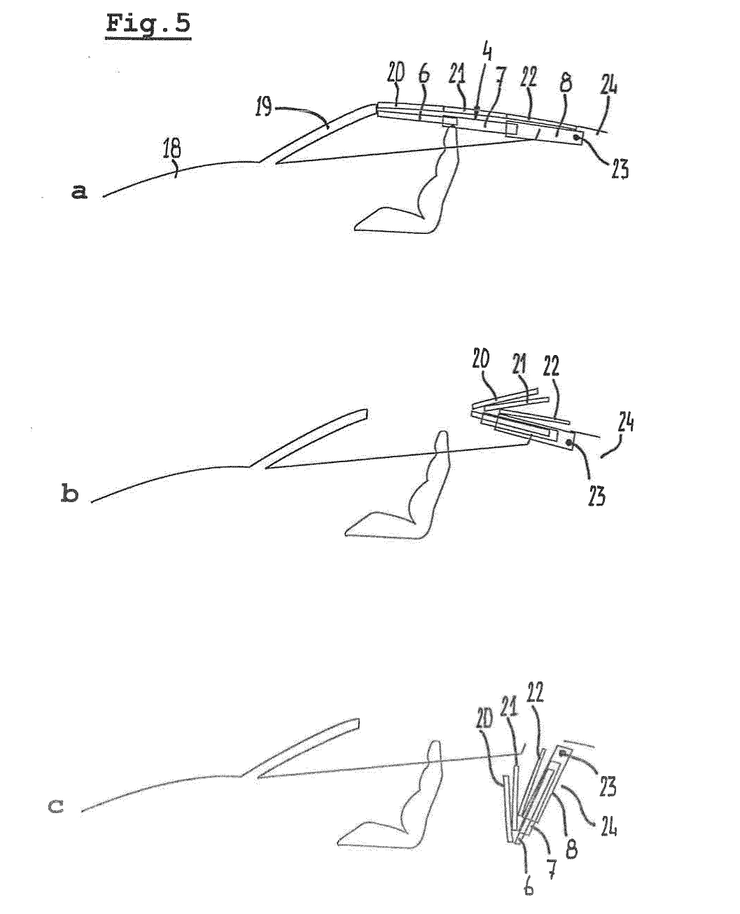

Next, reference is made to FIG. 5 illustrating a fifth embodiment of the open roof construction. In a schematic side elevational view part of the vehicle body 18 is illustrated with a wind shield area 19 and a trunk area 24. A telescoping mechanism 4 with telescoping members 6-8 and roof panels 20-22 attached thereto is provided. In a closed position (FIG. 5a) the leading roof panel 20 substantially abuts the wind shield area 19.

It is noted that the embodiment according to FIG. 5 also may comprise two telescoping mechanisms 4 located substantially at the opposite longitudinal edges of said roof panels 20-22.

Whereas in the embodiments of the open roof construction according to FIGS. 1-4, each telescoping mechanism 4 moves in a fixed direction, in the present embodiment each telescoping mechanism 4 can move in a variable direction. As represented schematically, each telescoping mechanism 4 is mounted for a rotation about an axis of rotation 23 extending substantially in a transverse direction (of the vehicle).

In the illustrated embodiment of the open roof construction the telescoping mechanism 4 is devised for firstly carrying out its translating telescoping movement (from FIG. 5a to FIG. 5b) and next its rotation about said axis of rotation 23 (from FIG. 5b to FIG. 5c).

It is conceivable, however, that the telescoping mechanism 4 is devised for carrying out its telescoping movement and its rotation about said axis of rotation 23 at least partly simultaneously (and synchronised) or in any other order or combination of movements.

In the embodiment of the open roof construction according to FIG. 5, the telescoping mechanism 4 is devised for, in their fully opened position, positioning the roof panels 20-22 in a trunk being part of the trunk area 24.

In accordance with some aspects of the previous embodiments, the open roof construction according to the embodiment illustrated in FIG. 5 may comprise a roof opening with two opposite longitudinal edges which are defined by cant rails (not illustrated here) which are devised for maintaining their position along said longitudinal edges when the panels 20-22 move between the closed and opened positions or which are devised for moving along with the panels when these move between the closed and opened positions. In the latter case such cant rails again may comprise a number of cant rail members (not illustrated here) attached to longitudinal side edges of respective ones of the roof panels 20-22, which cant rail members then may be provided with cooperating connecting members for establishing a connection between successive cant rail members in the closed position of the roof panels.

In the embodiment according to FIG. 5 the roof panels 20-22 are attached to the respective telescoping members 6-8 in a manner to allow a change of the relative position between a roof panel and the corresponding telescoping member, for example through an axis of rotation (not illustrated here) extending substantially in a transverse direction.

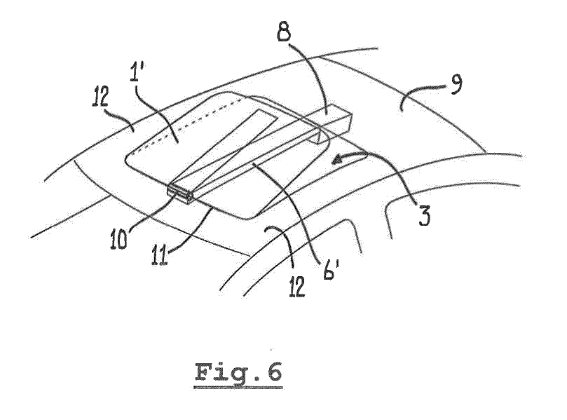

Finally, FIG. 6 shows an embodiment of the open roof construction according to the invention in a situation similar to FIG. 1b. In this case, however, only one roof panel 1′ attacked to a telescoping member 6′ is provided.

The invention is not limited to the embodiments described before which may be varied widely within the scope of the invention as defined by the appending claims.

1. An open roof construction for a vehicle, comprising a number of separate roof panels which are movable between a closed position for closing a roof opening of said vehicle and an opened position for at least partially freeing said roof opening, and a telescoping mechanism configured to move said number of roof panels, substantially in a longitudinal direction of the vehicle, between the closed and opened positions, which telescoping mechanism is provided with a number of telescoping members which in a telescoping manner are movable relative to each other and wherein each panel is attached to and moved by a different one of said telescoping members.

2. The open roof construction according to claim 1, wherein the telescoping mechanism comprises a single telescoping mechanism located substantially along a longitudinal center line of said roof panels.

3. The open roof construction according to claim 1, and further comprising a second telescoping mechanism, the telescoping mechanism and the second telescoping mechanism located substantially at the opposite longitudinal edges of said roof panels.

4. The open roof construction according to claim 1, wherein the telescoping mechanism moves in a fixed direction.

5. The open roof construction according to claim 1, wherein the telescoping mechanism moves in a variable direction.

6. The open roof construction according to claim 5, wherein the telescoping mechanism is mounted for a rotation about an axis of rotation extending substantially in a transverse direction.

7. The open roof construction according to claim 6, wherein the telescoping mechanism is configured to carry out telescoping movement and rotation about said axis of rotation substantially successively.

8. The open roof construction according to claim 6, wherein the telescoping mechanism is configured to carry out telescoping movement and rotation about said axis of rotation at least partly simultaneously.

9. The open roof construction according to claim 1, wherein the telescoping mechanism is attached to the vehicle at a position behind the roof opening, as seen in the longitudinal direction of said vehicle, such that the panels, when moved to the fully opened position, are located substantially behind said roof opening.

10. The open roof construction according to claim 1 for a vehicle of the type having a rear trunk, wherein the telescoping mechanism is configured to position the panels in their fully opened position in said trunk.

11. The open roof construction according to claim 1, wherein the roof opening comprises two opposite longitudinal edges which are defined by cant rails which are configured to maintain their position along said longitudinal edges when the panels move between the closed and opened positions.

12. The open roof construction according to claim 1, wherein the roof opening comprises two opposite longitudinal edges which are defined by cant rails which are configured to move along with the panels when the panels move between the closed and opened positions.

13. The open roof construction according to claim 12, wherein each cant rail comprises a number of cant rail members attached to longitudinal side edges of respective ones of the roof panels, which cant rail members are provided with cooperating connecting members configured to establish, in the closed position of the roof panels, establishing a connection between successive cant rail members.

14. The open roof construction according to claim 1, wherein the roof panels are attached to the respective telescoping members a manner to allow a change of the relative position between a roof panel and the corresponding telescoping member.

15. The open roof construction according to claim 14, wherein each roof panel is attached to a respective telescoping member through an axis of rotation extending substantially in a transverse direction.

16. An assembly for an open roof construction for a vehicle, comprising a number of separate roof panels which are movable between a closed position for closing a roof opening of said vehicle and an opened position for at least partially freeing said roof opening, and a telescoping mechanism configured to move said number of roof panels) between the closed and opened positions, which telescoping mechanism is provided with a number of telescoping members which in a telescoping manner are movable relative to each other and wherein each panel is attached to and moved by a different one of said telescoping members.

17. The open roof construction according to claim 16, wherein the telescoping mechanism comprises a single telescoping mechanism located substantially along a longitudinal center line of said roof panels.

18. The open roof construction according to claim 16, and further comprising a second telescoping mechanism, the telescoping mechanism and the second telescoping mechanism located substantially at the opposite longitudinal edges of said roof panels.

19. The open roof construction according to claim 16, wherein the telescoping mechanism moves in a fixed direction.

20. The open roof construction according to claim 16, wherein the telescoping mechanism moves in a variable direction.
